(19) United States
(12) Patent Application Publication
(10) Pub. No.: US 2013/0091183 A1
(43) Pub. Date: Apr. 11, 2013

(54) Volume Management

(71) Applicants: Nigel Edwards, Bristol (GB); Lawrence Wilcock, Malmesbury (GB)

(72) Inventors: Nigel Edwards, Bristol (GB); Lawrence Wilcock, Malmesbury (GB)

(21) Appl. No.: 13/704,100

(22) PCT Filed: Jun. 15, 2010
(86) PCT No.: PCT/US10/38666

§ 371 Date: Dec. 13, 2012

(51) Int. Cl. G06F 17/30

(52) U.S. Cl. CPC G06F 17/30002
USPC 707/803

(57) ABSTRACT

A volume management system (300) in a cloud computing environment is disclosed. The volume management system (300) is useable by a plurality of users (301-1 . . . 301-N) and is configured to allow a user to create and manage volumes (304, 305, 306) and to allow said volumes to be attached to virtual machines created in said cloud computing environment wherein a record of each volume created is stored in a structured hierarchical directory. A method of managing volumes in a cloud computing environment and a volume management cell for managing volumes in a cloud computing environment are also disclosed.

### BACKGROUND

Cloud computing environments provide computing infrastructures that are abstracted from the underlying physical hardware. Cloud computing environments may deliver Infrastructure-as-a-service (IaaS) by providing the ability to create virtual machines (VMs) on demand having defined attributes such as size, operating system, number of block devices etc. These VMs, which may be formed as encapsulated networks, are carved out of the underlying physical hardware.

FIG. 1 illustrates an example of a cloud computing environment. In the example shown in FIG. 1, a physical computing hardware infrastructure 101 is shown. The physical computing hardware infrastructure could, for example, comprise one or more data centres or the like comprising a plurality of servers, one or more supercomputers or any collection or network of computing resources. The physical hardware may be owned and controlled by one organisation and made available to other organisations, for instance as part of an Infrastructure-as-a-service and/or Platform-as-a-service business, or the hardware could be the hardware of a single organisation operated as a cloud computing environment for its own users.

The physical hardware can be used to provide appropriate VMs on demand to users. The VMs are associated with volumes, i.e. virtual disks, for operation and data storage. In one implementation, the VMs and volumes are provided within cells, with each cell being an encapsulated network comprising one or more VMs and/or volumes. A cell, in an implementation of a cloud computing environment, is a virtualized infrastructure, derived from the underlying physical infrastructure, which may be separated from other virtual resources provided by the same physical infrastructure by encapsulation. In other words a cell is a collection of virtual resources which may be isolated within a virtual security boundary and wherein network security rules may control any data traffic into or out of the cell. A cell therefore may provide a virtual network that may be connected to a wider network and in which network security rules may mean that one cell is isolated from another cell, other than through connection rules that can be controlled by the owner of the cell. By default each cell may be completely isolated from all other cells although the owner of a cell can control interaction of the cell with external entities through network access rules.

Within a cell, one more virtual machines may be instantiated and may form a virtual network. Volumes are components of a cell. In the context of cloud computing, a volume is a virtual component accessible by a VM, that provides persistent storage for persisting the state of a VM or an image or components used to form a VM. In the context of cloud computing a volume is abstracted from any underlying physical storage hardware and thus is separate from and not tied to any particular storage resource or type of resource but provides a single, distinct virtual storage resource with defined attributes such as size.

FIG. 1 shows a first user, 102, running two cells, 103 and 104. The user 102 accesses the cells via a user interface provided by the user's local workstation for example.

The user 102 specifies the number and attributes of VMs and associated volumes for the cell. Cell 103 shows an illustrative network of several VMs 105-1 to 105-5 each having an associated volume 106-1 to 106-5. Cell 104 shows an illustrative network comprising a single VM 107 having three associated volumes 108-1 to 108-3. FIG. 1 also illustrates another user 109 running a different cell 110.

A VM is typically created using a machine image of the desired VM. The machine image is effectively a template that provides the VM with a bootable operating system and defined software applications. A machine image is typically cloned onto a volume which is mounted to the VM, i.e. attached to the VM for write and read access. The VM may be created with various volumes attached to it, such as bootable volumes and storage volumes. FIG. 2 illustrates how a selected image 201 may be cloned to create a volume 202 which is then mounted to a VM 203.

The ability to rapidly create large numbers of VMs can lead to the phenomenon referred to as virtual machine sprawl, with large number of VMs created with little control over the resources consumed. For example, in developing a particular platform service or application, various development VMs may be created before a final production machine is created. VMs which are shutdown and run only occasionally still consume resources in terms of the volumes attached to the inactive VMs.

Image sprawl also may occur when users requiring a particular VM create a new machine image to be used to instantiate the desired machine. Over time the number of images may increase substantially, which can represent a significant management issue. For example, images may be public, i.e. available to be cloned by any users of the cloud computing environment, but, determining whether an image for a desired VM exists may not be a simple task.

### BRIEF DESCRIPTION OF THE DRAWINGS

Implementations will now be described by way of example only with reference to the following drawings, of which:

FIG. 1 illustrates an example of a cloud computing environment and a number of cells;

FIG. 2 illustrates an example cloning of an image to create a volume attached to a VM;

FIG. 3 illustrates an example of an implementation of a volume management system;

FIG. 4 illustrates an example of a directory structure that may be implemented using a volume management system;

FIG. 5 illustrates an example of editing volumes within an example of a volume management system;

FIG. 6 illustrates an example of a platform service using an example of a volume management system;

FIG. 7 shows a flowchart illustrating an implementation of a process for searching for volumes; and

FIG. 8 shows a flowchart illustrating an implementation of a process for editing volumes.

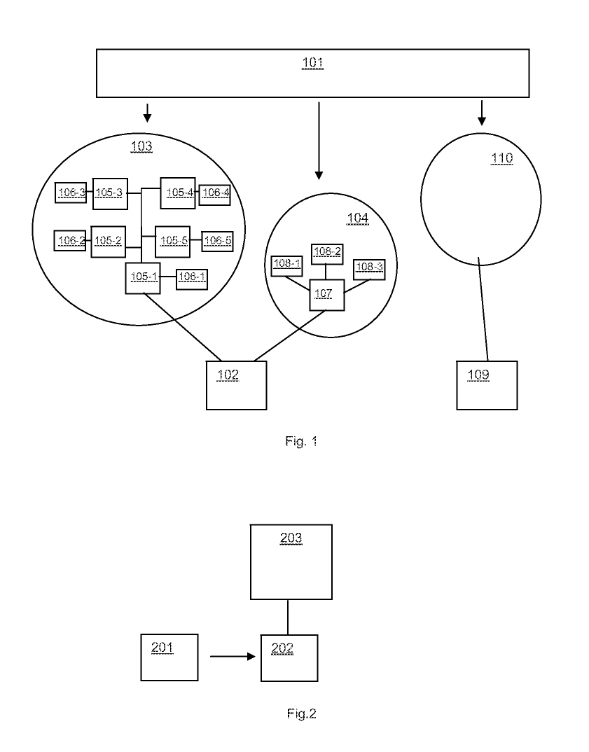

### DETAILED DESCRIPTION

To address virtual machine sprawl and image sprawl, cloud computing environments may provide lists of public images and lists of their existing volumes but, with increasing numbers of images and volumes, such lists may be difficult to navigate and use effectively.

FIG. 3 illustrates an implementation of a volume management system 300 in a cloud computing environment that allows users to readily manage their volumes. The volume management system is useable by a plurality of users 301-1 to 301-N and is configured to allow a user to create new volumes and to allow said volumes to be attached to virtual machines created in said cloud computing environment. The volume management system maintains a record of all volumes created in a structured hierarchical directory.

The volume management system in effect operates as a platform service concerned with the management of volumes. The volume management system may recognise different types of volumes. There will be volumes which are intended to be attached to and used by virtual machines created outside of the volume management. Such volumes may be referred to as cell volumes. Cell volumes may be bootable. Volumes containing an image that can be used to instantiate a VM and which are used to create cell volumes may be referred to as Golden Images. In some implementations, Golden

Images may only be used to create clones, rather than being directly attached to a VM in use, to prevent accidental modification. Component volumes are volumes which are intended to contain useful application components, for example RPM files and disk ISOs, which can be used to compose new cell volumes and Golden images. In some implementations, component volumes may not be used directly by a VM outside of the volume management system.

The volume management system hence provides a volume and image management service. The system allows ease of lifecycle management of volumes which is independent of the virtual machines and networks with which the volumes may be used. In some implementations, the volume management system provides the ability for fine grained secure sharing of volumes between groups of users.

As illustrated in FIG. 3, the volume management system 300 may be implemented within its own cell 302 in a cell based environment. The volume management system 300 need not have any special relationship with the cloud computing environment, i.e. the infrastructure services that can be provided, and the volume management system 300 may be implemented as any other platform or application services. The volume management service 300 is multi-tenant, providing volume management services for multiple users and may provide management services for any users able to use the infrastructure service. A single instance of a volume management system 300, therefore, may be sufficient for a single cloud computing environment. However multiple instances of the volume management service 300 can be created if desired, for instance to provide volume management services to distinct groups.

The volume management system 300 may comprise a VM which acts as a volume management server 303. The volume management server 303 can be accessed by users to provide volume management functions such as, for example, listing of volumes in a structured directory, searching of volumes, listing of attributes of the volumes, editing of attributes of the volumes, creation of new volumes and/or cloning of volumes.

Each user 301-1 to 301-N may communicate with the volume management server 303 using an appropriate user interface. For example a user may use a web browser type UI, such as the Google Web Toolkit GUI for instance, on the user's workstation to communicate with the volume management server 303 using, for instance an HTTP/SSL protocol. Communications between the user and the volume management server 303 may be encrypted, for instance using a public key encryption scheme such as X509. The user may therefore be required to authenticate the user's identity to establish a session with the volume management server 303.

Having successfully established a session the user may browse the volume management system directory structure.

In one implementation, the volume management system 300 may present a hierarchical directory structure to its users. The structure may be preconfigured or may be configurable by the user. In the implementation shown in FIG. 3, the default hierarchical structure has two top level directories: “users” and “public”. Under “users,” each user has a private directory in which to place volumes, for instance volumes that are not intended to be shared with other users. However, as will be described later, in some implementations, users may be able to specify that volumes contained in such a directory may be shared with other users or groups of users. Within each private user directory, the structure may be divided into cell volumes 304 and source volumes. The source volumes directory may further be subdivided into a directory for Golden Images 305 and a separate directory for component volumes 306, i.e. volumes containing software applications and tools that may be used to create new images and volumes but which may not be attached to a VM.

Within the “public” directory, there may be a directory for each user in which to store publicly available source volumes, e.g. images that can be cloned by other users to make their own volumes. Again the public directory for each user may be sub-divided into a directory for Golden Images 307 and component volumes 308. The “public” directory may also have a directory such as “system” containing publicly available images which are generally provided by the entity providing the cloud computing environment. This may include a library of tools that allow users to build their own platform services and applications using the volume management system, such as virus checking applications, patching and compliance testing for example.

Within any of the directories, further structure may be defined by the user based on any hierarchical structure desired by the user, for example separate directories for different applications and/or separate directories for production volumes/images and development volumes/images. Any type of tree structure may be used.

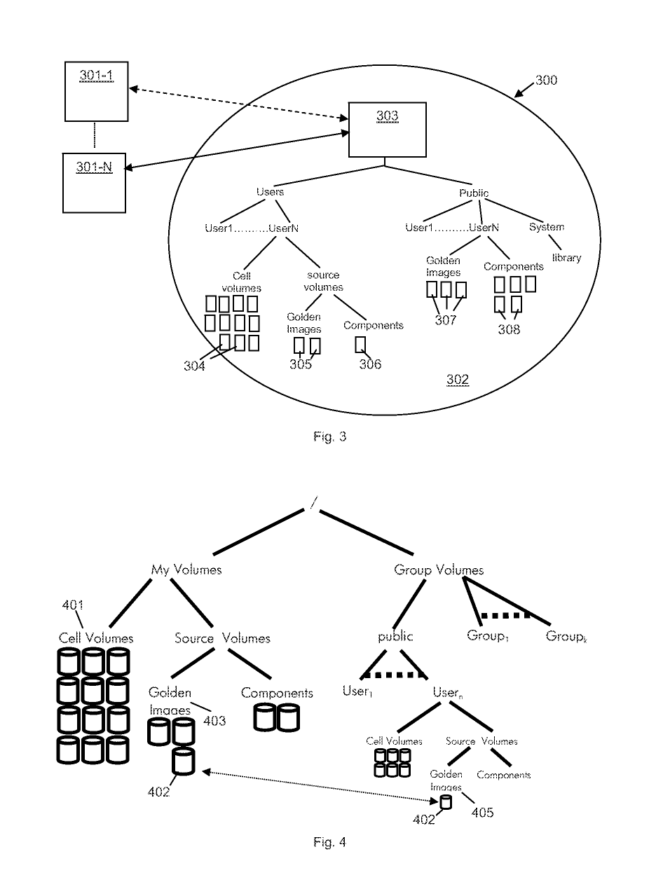

The directory structure may also comprise directories for groups of users. For example, FIG. 4 shows another example of a directory structure of a volume management system that may be presented to an individual user. This directory structure provides a default top level directory structure comprising “My Volumes” and “Groups”. By default, “My volumes” is used to store volumes that are not shared with other users and again may be subdivided into cell volumes and source volumes. The “Groups” directory may be subdivided into directories for various groups Group₁ to Groupₖ. Access to a group directory may be limited to users which are identified as members of the relevant group as will be described further later. There may also be a “public” group directory. In effect, the public group may be a group consisting of all users. Each individual group directory may be further divided as required, for instance, as described above, there may be a separate directory for each user which is further subdivided into cell volumes and source volumes.

Each volume managed by the volume management system may have one or more attribute fields associated with it. These attributes fields may be stored as metadata regarding the volume and may be used in management of the volume. Some attributes may be common to all volumes, for instance the owner of the volume, a digital signature, the size of the volume, whether the volume is bootable and whether the volume is immutable. Other attributes may include a change log, which may be an append only log to maintain details about the date of creation of the volume and all changes made to the volume.

The user may also be able to define new attributes fields to be associated with the volumes which will be stored by the volume management system to aid in identification, searching and management of the volumes. For instance the user-defined attributes may indicate the operating system of the volume and include a description of the volume.

The user can also set access rights for other users or groups of users for the volumes. The access rights may be divided into rights governing the ability of other users to interact with the volume within the volume management system, which will be referred to herein as grant rights, and rights governing the ability of other users to use the volume, i.e. the ability for the volume to be attached to an external VM or cloned for use with an external VM, which will be referred to herein as export rights.

The grant rights attributes may comprise a series of permissions. For example, read permission might allow a user to discover the volume, i.e. to see the volume listed in the directory structure and to read the content of the volume within the volume management system, for example via the volume management server 303 or a volume task VM instantiated within the volume management system as will be further described below. A user that is given read permission as part of a grant right may also be able to read the information maintained by the volume management system about the relevant volume, for instance the metadata such as the attributes. Read permission may, by default, allow a user to read both the content and at least some of attributes or metadata stored for the volume. However some attributes may require specific read permission in order to read that attribute. Write permission may allow the user to write to the volume within the volume management system. There may be a separate permission to allow a user to edit the attributes of the volume. As the set of access rights may themselves contain sensitive information in some instances, for instance by identifying the users with access to particular volumes, there may be separate read permissions required to be able to read and/or edit the access rights. For instance the owner of a volume may specifically want to control who can modify the export rights for the volume.

Export rights may include read and write access to the volume by external VMs in other cells. Thus export rights may govern the ability to read and write to the volume from outside of the volume management system. Export rights may also be set to allow a user or group of users or a specified application to clone the volume to create a new volume or to mount the volume on a VM.

The access rights can be set for specified users or groups of users. The access rights may also be based on the concept of a role, so that access rights apply to any user having the authenticated role. Thus, for example, for a specified volume, the owner of the volume may allow all users to read the volume and also allow a specified group of users, or users having a specified role, to write to the volume. However the ability to read the access rights and/or edit the attributes may be reserved for the owner of the volume.

The volume management system may also have access rights associated with the directory structure. Each node in the directory structure, i.e. each individual directory or sub-directory, such as, for example, the “MyVolumes/CellVolumes” node 401 in FIG. 4, may have access rights defined in a similar fashion as described for the individual volumes. The access rights for the node may govern which users or groups of users can access the specified directory to see the contents of the directory and also which users or groups of users can add volumes to that directory. The access rights for the node may be used as a default for any volumes created under that node, i.e. in the particular directory. By default, each user directory, e.g. “My volumes” for each user in the structure of FIG. 4 or “userₓ” in the structure of FIG. 3, may be restricted to that user alone, i.e. no other user can see into that directory without specific permission of the directory owner. By default, any group directory may likewise by restricted to that group of users. By default, each public directory may be read access for all users.

In some implementations, the volume management system may allow a user to link a volume to more than one directory. In this way, a particular volume may be listed in two directories. Referring to FIG. 4, volume 402 may be linked with node 403, i.e. the Golden Images subdirectory for the user, and also with node 405 the public Golden Images directory for that user.

As the volume management system can therefore securely control the access of users and external entities to volumes and/or directories of volumes on the basis of individual users or groups of users or specified role, the volume management system provides the ability to provide fine-grained sharing of resources between multiple users and work-groups in a secure manner.

As well as providing a hierarchical directory structure to allow users to quickly navigate to the desired volumes, the volume management system may provide search functionality. Searching may be conducted on the name or part of the name of the volume and/or on any of the attributes of the volume. Searches may be conducted on any of the common attributes of all volumes and/or the user defined attributes. In some implementations, the access rights of the volumes and directories control the results of the search. For example, a user may need to have read access for a volume and/or the directory it is located within in order to discover the volume during a search.

Search functionality may be provided via the user interface on the user's workstation. Searching may be performed, for example, by allowing a user to select one or more attributes to be searched and to input or select a search term to be searched for that attribute. As mentioned above, there may be some static attributes that are common to all volumes, such as description, size, owner etc. There may also be user specified attributes which may comprise user defined name-value pairs and which may stored for instance in allocated fields in metadata. The user may be able to search for common and/or user-defined attributes

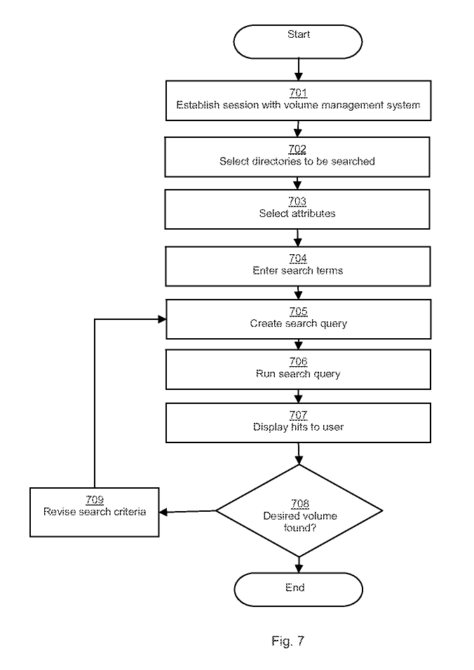

FIG. 7 shows a flowchart illustrating one implementation of a searching process.

At step 701 the user establishes a session with the volume management system, which may cause a search screen of the user interface to be brought up. At step 702 the volume management system enables the user to select the directories to be searched. The user may be able to select more than one directory to be searched and may be able to select whether or not the search includes any sub-directories below the level of the selected directories. As mentioned above, the volume management system may enable the user to search only directories for which the user has read permission within the volume management system, e.g. a grant right read permission. At step 703 the user selects one or more attributes to be searched. At step 704 the user enters one or more search terms. The search terms may be selectable from a drop-down list and or may be manually input. For appropriate types of attributes the user may specify ranges or the like. The search functionality may involve pattern matching and the use of wildcard characters may be allowed. The steps of selecting the directories, attributes and search terms may use Boolean type operators to allow conditional searching for one or more terms in one or more attributes. In some implementations, the order of specifying the directories, attributes and search terms may be varied and the user may be able to complete these steps in any order with default values being applied in the absence of any positive selection being made.

At step 705 the volume management system creates an appropriate searching query, for example an SQL search query, based on the user-supplied search criteria. At step 706, the search query is performed on the metadata to identify any hits. Any hits may be presented to the user in step 707, for instance via a ranked list displayed on the user interface. If, in step 708, the user determines that a desired volume has been identified, the volume management system may enable the user to select the relevant volume or directory for further action. However if the desired volume has not been found, the volume management system may enable the user to refine the search criteria in step 709 in order to construct a new search query.

As well as providing ease of location of volumes, the volume management system may also provide the ability to create, destroy and edit volumes.

For example, in order to create a new empty volume, the user may instruct the volume management system to create a new empty volume in a specified directory. The user creating the volume is taken to be the owner of the volume, unless otherwise specified, and the user can define the attributes of the volume or, alternatively, the volume may be created with default attributes which can later be edited by the user.

The volume management system may provide a variety of management tools such as fdisk, mkfs, dd, rpm, yast and others for Linux and similar utilities for other operating systems. In one implementation, in order to edit volumes, the volume management system creates a volume task VM on demand for the user to run volume management tools. The volume task VM is created within the volume management system cell and may be specific to that user for security.

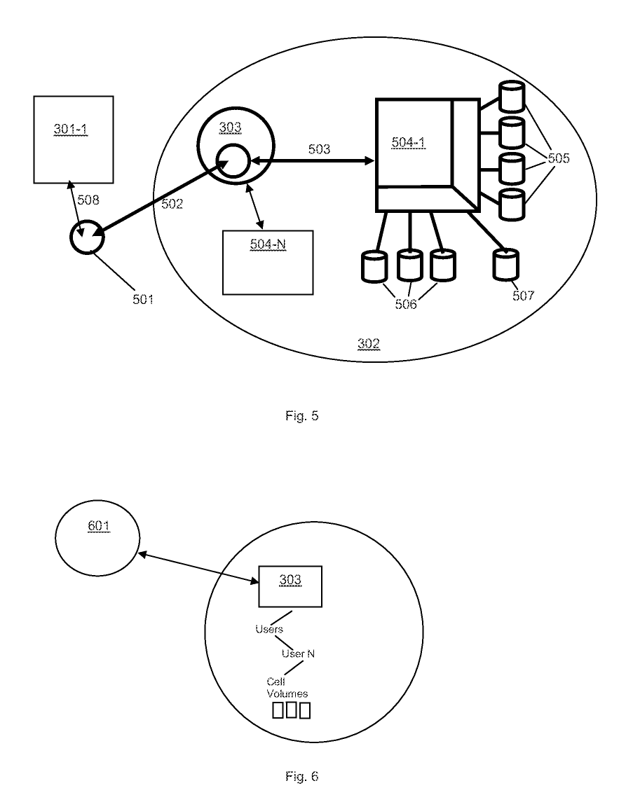

Referring to FIG. 5, a user 301-1 selects the desired volumes to be edited using the user interface and structured directory and/or search functionality discussed above. The user identifies source volumes for the volume task VM that are to be mounted as read only volumes. The source volumes may comprise Golden Images and/or component volumes but may additionally or alternatively comprise other cell volumes from which data is to be copied. The user also selects target volumes that are to be mounted as read-write to the volume task VM to which data may be copied. Once the source and target volumes for the volume task VM have been identified, and provided that the user has the necessary access rights to those volumes, the volume management system creates the volume task VM 504-1 for the user 301-1, with the source volumes 505 being mounted for read only access and the target volumes 506 being mounted for read-write access. The volume task VM will also be mounted to at least one ephemeral disk 507 created for the VM to provide a root disk and a boot disk.

The user communicates with the volume task VM via the volume management server 303. In some implementations the communication between the user and the volume task VM is encrypted for security, for example by a public key encryption protocol. In one implementation, an SSH link between the user and a proxy 501 on the user's workstation is used, with packets being tunnelled over an SSH/HTTP/SSL link 502 to the volume management server 303. The tunnel is terminated inside the volume management server 303 which will forward packets only to the relevant user's volume task VM.

With the volume task VM, the user can run whatever tools the user chooses, and the machine may be configured to run at least one volume management application specified by the user, i.e. the volume task VM can run conventional off-the-shelf volume management products. This allows users to utilise familiar tools to manage their volumes with a high degree of flexibility.

Some volume tasks may not require a volume task VM to be instantiated and the volume management server may be arranged to utilise any management functionality of the underlying storage systems. For instance, to create a clone of an existing volume the user may instruct the volume management system, via the user interface on the user's workstation, to create a new volume that is an independent replica of an existing volume. Provided that the user has the necessary access rights the volume management server may take advantage of an underlying facility to copy the relevant volume, such as a Copy-on-Write facility or a ‘snapClone’ facility or the like.

Using the volume management system, new clones of volumes can be created for use with VMs running outside of the volume management system. For example, a Golden Image may be cloned as a new cell volume for use with a new VM.

A copy of a volume may also be created from an existing volume by instantiating a volume task VM. For example a user may create a new empty volume using the volume management system. The user may then instantiate a volume task VM with the empty volume mounted as a target volume and the Golden Image mounted as a source volume. The data from the Golden Image can then be copied to the target volume. Use of the volume task VM may allow greater functionality for editing volumes and creating a volume based on several existing volumes.

Updating or editing of data on the volume may also be performed by instantiating a volume task VM. For instance, updating of data on a component volume may be performed by mounting the relevant component volumes as target volumes to the volume task VM with the relevant volumes containing the update data as source volumes. Data, such as update data, can be uploaded to the relevant volumes in the volume management system by instantiating a volume task VM with the specified volumes attached as target volumes. Data can then be uploaded to the volume management system via the secure link, for example over SSH using a sftp utility. The uploaded data can be written to the relevant target volumes by the volume task VM.

After editing is completed, the volume task VM can be dissolved but the source and target volumes will persist. The target volume may have its attributes and access rights edited and the access rights may be set to allow the volume to be mounted to an external VM.

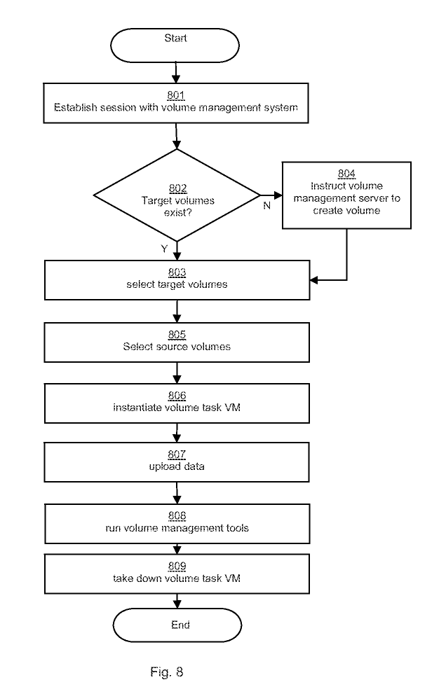

FIG. 8 shows a flowchart illustrating one implementation of a process for editing volumes.

At step 801, the user establishes a session with the volume management server. As described above, this may be accomplished using a secure protocol such as HTTP/SSL. At step 802, the user uses the volume management system to determine whether the target volumes to be edited exist, for instance by browsing the directory structure or using a search facility via the user interface on the user's workstation. If the target volumes do exist, the method passes to step 803. However, if a desired target volume does not exist, the user may initially instruct the volume management server at step 804 to create a volume. This could be a new empty volume or it could be a clone of an existing volume which it is wished to edit whilst maintaining the original.

At step 803, the target volumes it is wished to edit are selected and identified as target volumes. At step 805, any source volumes containing data to be used to edit the target volumes are identified. The user then instructs the volume management server to instantiate a volume task VM for that user in step 806. Provided that the user has the correct access rights to the designated volumes, the volume task VM is created attached to the designated volumes. The volume task VM may be attached to any designated source volumes as read-only volume and to the designated target volumes as read-write volumes.

At step 807, if the user wishes to upload any data to any of the target volumes, the volume management system enables the user to upload data via a secure protocol such as SSH to transfer data to the volume task VM and then the relevant target directory. At step 808, the volume management system enables the user to run any volume management tools on the volume task VM and perform any editing tasks required.

Once editing is completed, the volume task VM is taken down at step 809 and the target volumes remain as edited volumes that can be used in accordance with the appropriate access rights.

As mentioned above, the volume management system may be multi-tenant and thus there may be several users each performing volume editing tasks at the same time. A separate volume task VM may be created for each user, for instance volume task virtual machine 504-N may be provided for a different user. In one implementation, each volume task VM is configured to communicate with the volume management server 303 only and not with other volume task VMs.

In one implementation, the volume management system has a REST API for ease of use with other platform applications and services such a virus scanners, compliance testers, indexers and the like. As mentioned above, the volume management system may comprise a client REST library to make it easy for developers to build new services using the volume management system.

FIG. 6 illustrates a platform service 601 such as a virus scanner which securely communicates with the volume management server 303. The volume management server 303 checks whether the platform service 601 has access rights to the volumes in a desired directory and, if so, allows the platform service 601 to access the relevant volumes. A service such as a virus scanner may read the content of a volume and check it for the presence of viruses. The scanner may then update the attributes of the relevant volumes based on the outcome.

The volume management system therefore provides, within a cloud computing environment, a structured directory of volumes and images. The structure may be configurable and any tree structure may be possible. The volumes may be searchable by name and/or attribute, and the attributes may be extensible with user defined attributes. Access rights may be set for the volumes and for the nodes of the directory structure. The access rights may provide access rights for access within the volume management system and also for rights of use of the volume by external VMs. In this way, secure fine-grain sharing of volumes between workgroups and users is possible. The notion of workgroup or role may be supported for easy administration.

Editing and management of volumes may be performed by creating a volume task VM which can support any desired volume or image management tool. Networking rules within the volume management system may be configured so that multiple volume task VMs can be run securely in the same environment.

The volume management system may have a REST API for ease of development of additional services using the volume management system.

The volume management system may be provided as a computer program product for use with a suitable computing system. The computer program product may comprise computer readable code stored on a tangible (e.g., non-transitory), computer readable storage medium that, when executed in said computing system, causes it to provide an implementation of a volume management system in a cloud computing environment as described above. Examples of suitable computer readable storage media include semiconductor memory devices, such as Erasable Programmable Read-Only Memory (EPROM), Electrically Erasable Programmable Read-Only Memory (EEPROM), and flash memory devices, magneto-optical disks, and Compact Disc Read-Only Memory (CD-ROM).

Implementations of the present invention therefore provide methods of managing volumes in a cloud computing environment. The method may comprise providing, to each of a plurality of users, a structured hierarchical directory of volumes to which each said user has access rights, and providing a tool to allow users to create new volumes and to manage existing volumes.

In an implementation, a volume management cell for managing volumes in a cloud computing environment comprises: a volume management server accessible by a plurality of users and configured to provide users with a hierarchical directory of volumes for which each user has access rights and to create, on demand by a user, a temporary volume task machine wherein said temporary volume task machine is only accessible by said user and is attached to volumes specified by the user to provide editing utilities for at least some of said volumes. The volume management cell may be configured to allow users to set access rights for specified users, groups of users and external entities.

It should be noted that the above-mentioned implementations are illustrative rather than limiting, and that implementation modifications are possible. The word “comprising” does not exclude the presence of elements or steps other than those listed in a claim, and use of the terms “a” or “an” does not necessarily exclude a plurality. Any reference signs in the claims shall not be construed so as to limit their scope.

1. A volume management system in a cloud computing environment wherein said volume management system is useable by a plurality of users and is configured to allow a user to create and manage volumes and to allow said volumes to be attached to virtual machines created in said cloud computing environment wherein a record of each volume created is stored in a structured hierarchical directory.

2. A volume management system as claimed in claim 1 wherein the structure of said structured directory is configurable for each user.

3. A volume management system as claimed in claim 1 configured to allow a user to define and store user-defined attributes for created volumes.

4. A volume management system as claimed in claim 3 configured to allow a user to search for volumes based on the attributes.

5. A volume management system as claimed in claim 1 wherein access rights can be set for one or more of the user's volumes and for one or more of the user's directories wherein said access rights can be granted to one or more specific users, groups of users or external entities.

6. A volume management system as claimed in claim 5 wherein the access rights comprise separate grant rights and export rights wherein grant rights govern the interaction of another user or entity with the volume or directory within the volume management system and wherein export rights govern the interaction of another user or entity with the volume from outside of the volume management system.

7. A volume management system as claimed in claim 1 configured to, on demand, create a volume task virtual machine for a user wherein the volume task virtual machine is attached to defined volumes.

8. A volume management system as claimed in claim 7 wherein said volume task virtual machine is configured to run at least one volume management application specified by a user.

9. A volume management system as claimed in claim 7 configured so that the volume task virtual machine of one user can not communicate with a volume task virtual machine of another user.

10. A volume management system as claimed in claim 1 comprising a volume management server wherein each user communicates with the volume management system via the volume management server.

11. A volume management system as claimed in claim 1 comprising a REST API.

12. A volume management system as claimed in claim 1 configured to be useable by external applications having appropriate authorizations.

13. (canceled)

14. A method of managing volumes in a cloud computing environment comprising:
providing, to each of a plurality of users, a structured hierarchical directory of volumes to which each said user has access rights, and
providing a tool to allow users to create new volumes and to manage existing volumes.

15. A volume management cell for managing volumes in a cloud computing environment comprising:
a volume management server accessible by a plurality of users and configured to provide users with a hierarchical directory of volumes for which each user has access rights and to create, on demand by a user, a temporary volume task machine, wherein
said temporary volume task machine is only accessible by said user and is attached to volumes specified by the user to provide editing utilities for at least some of said volumes.
